(19) United States
(12) Patent Application Publication
(10) Pub. No.: US 2026/0042481 A1
(43) Pub. Date: Feb. 12, 2026

(54) STEERING ACTUATOR, ELECTROMOTIVE STEERING DEVICE AND VEHICLE INCLUDING THE SAME

(71) Applicant: HL MANDO CORPORATION, Gyeonggi-do (KR)

(72) Inventor: Seongmoo HEO, Gyeonggi-do (KR)

(21) Appl. No.: 19/063,307

(22) Filed: Feb. 26, 2025

(30) Foreign Application Priority Data
Aug. 9, 2024 (KR) 10-2024-0107167

(51) Int. Cl. B62D 5/04

(52) U.S. Cl. CPC B62D 5/0454; B62D 5/0409

(57) ABSTRACT

The present embodiments relate to a steering actuator, an electromotive steering device, and a vehicle including the same. More specifically, there may be provided a steering actuator, an electromotive steering device, and a vehicle including the same, which may prevent rattle noise due to backlash by compensating for the clearance due to wear between the pinion shaft gear and the output shaft gear.

### CROSS-REFERENCE TO RELATED APPLICATION

This application claims priority from Korean Patent Application No. 10-2024-0107167, filed on Aug. 9, 2024, which is hereby incorporated by reference for all purposes as if fully set forth herein.

### BACKGROUND

### Field

The present embodiments relate to a steering actuator, an electromotive steering device, and a vehicle including the same, which may prevent rattle noise due to backlash between the pinion shaft gear and the output shaft gear.

### Description of Related Art

In general, a vehicle electromotive steering device is a device capable of arbitrarily changing the traveling direction of the vehicle as intended by the driver. For example, an electromotive steering device may change the traveling direction of the vehicle by changing the angle of the wheels by transferring the rotational force of the steering wheel to the steering gear.

The electromotive steering device may use a steering actuator as an assist power mechanism to relieve the driver of force. Steering actuators may be divided into hydraulic steering actuators that assist steering force by operating a hydraulic pump using the force from the engine and electric steering actuators using an electric motor.

The hydraulic steering actuator has a structure that detects the rotation of the steering wheel, receives the rotational force from the engine to operate the hydraulic pump, and sends the hydraulic pressure to a driver such as the cylinder configured on the steering shaft or the rack bar to assist the driver's steering force.

The electric steering actuator has a structure that detects the rotation of the steering wheel and drives the motor that is installed on the steering shaft or the rack to assist rotation, thereby allowing the electromotive steering device to smoothly operate.

However, the electric steering actuator may be worn due to the structure in which the gear formed in the pinion shaft and the gear of the output shaft are directly engaged with each other. Further, when clearance occurs due to the wear of the gears, rattle noise may be generated due to backlash when it is driven.

### SUMMARY

The present embodiments may provide a steering actuator, an electromotive steering device, and a vehicle including the same, which may prevent rattle noise due to backlash by compensating for the clearance due to wear between the pinion shaft gear and the output shaft gear.

In an aspect, the present embodiments may provide a vehicle steering actuator comprising a pinion shaft connected to a steering shaft and having a first gear, an output shaft having a second gear rotatably engaged with the first gear of the pinion shaft, at least one first adjustment gear provided on the pinion shaft to be engaged with the second gear of the output shaft and configured to be linearly movable along a rotation shaft of the pinion shaft, at least one second adjustment gear provided on the pinion shaft to be engaged with the second gear of the output shaft and configured to be linearly movable along the rotation shaft of the pinion shaft wherein the first adjustment gear is movably disposed between the first gear and the second adjustment gear, and at least one elastic member having an elastic material and disposed between the first adjustment gear and the second adjustment gear.

The vehicle steering actuator may further comprise a worm operably connected to a driving motor to be rotatable by the driving motor, and a worm wheel provided on the pinion shaft and rotatably engaged with the worm.

The rotation shaft of the pinion shaft may protrude from the first gear of the pinion shaft. A key or a key recess may be formed in a rotational axial direction of the pinion shaft on an outer circumferential surface of the rotation shaft of the pinion shaft. The first adjustment gear and/or the second adjustment gear may have a key recess where the key of the pinion shaft is inserted or a key inserted to the key recess. The first gear and the second gear may be provided as helical gears of the pinion shaft.

The first adjustment gear and the second adjustment gear may have teeth having the same size as teeth of the first gear.

The elastic member may comprise a disc spring having a through hole through which the rotation shaft of the pinion shaft passes.

A width of the elastic member may be smaller than a width of the first gear of the pinion shaft.

The vehicle steering actuator may further comprise a stopper coupled to the pinion shaft to prevent the second adjustment gear from being separated from the pinion shaft. An outer circumferential surface of the pinion shaft has an anti-escape recess to which at least a portion of the stopper is inserted.

The stopper coupled to the pinion shaft may have an O-ring shape having an opening.

The first adjustment gear and the second adjustment gear may be linearly moved in opposite directions to each other by the elastic member to compensate for a clearance between the first gear and the second gear.

The at least one first adjustment gear may include a plurality of first adjustment gears, the at least one second adjustment gear may include a plurality of second adjustment gears, and the at least one elastic member may include a plurality of elastic members.

In another aspect, the present embodiments may provide an electromotive steering device comprising a driving motor configured to generate in response to a control signal received from a controller, a pinion shaft connected to the driving motor and having a first gear, an output shaft having a second gear rotatably engaged with the first gear of the pinion shaft, a first adjustment gear provided on the pinion shaft to be engaged with the second gear of the output shaft and configured to be linearly movable along a rotation shaft of the pinion shaft, a second adjustment gear provided on the pinion shaft to be engaged with the second gear of the output shaft and configured to be linearly movable along the rotation shaft of the pinion shaft,, wherein the first adjustment gear is movably disposed between the first gear and the second adjustment gear, and an elastic member having an elastic material and disposed between the first adjustment gear and the second adjustment gear.

The electromotive steering device may further comprise a worm operably connected to a driving motor to be rotatable by the driving motor, and a worm wheel provided on the pinion shaft and rotatably engaged with the worm.

The rotation shaft of the pinion shaft may protrude from the first gear of the pinion shaft. A key or a key recess may be formed in a rotational axial direction of the pinion shaft on an outer circumferential surface of the rotation shaft of the pinion shaft. The first adjustment gear and/or the second adjustment gear may have a key recess where the key of the pinion shaft is inserted or a key inserted to the key recess of the pinion shaft.

The electromotive steering device may further comprise a stopper coupled to the pinion shaft to prevent the second adjustment gear from being separated from the pinion shaft. An outer circumferential surface of the pinion shaft has an anti-escape recess to which at least a portion of the stopper is inserted.

In another aspect, the present embodiments may provide a vehicle comprising a steering angle setter configured to set a steering angle of the vehicle based on a driving path set by a driving path setter, and an electromotive steering device configured to assist a manipulation force of a steering wheel or perform steering based on the steering angle set by the steering angle setter, wherein the electromotive steering device may include a driving motor configured to generate power based on a control signal received from a controller, a pinion shaft connected to the driving motor and having a first gear, an output shaft having a second gear rotatably engaged with the first gear of the pinion shaft, a first adjustment gear provided on the pinion shaft to be engaged with the second gear of the output shaft and configured to be linearly movable along a rotation shaft of the pinion shaft, a second adjustment gear provided on the pinion shaft to be engaged with the second gear of the output shaft and configured to be linearly movable along the rotation shaft of the pinion shaft, wherein the first adjustment gear is movably disposed between the first gear and the second adjustment gear, and an elastic member having an elastic material and disposed between the first adjustment gear and the second adjustment gear.

The vehicle may further comprise a worm operably connected to a driving motor to be rotatable by the driving motor, and a worm wheel provided on the pinion shaft and rotatably engaged with the worm.

The rotation shaft of the pinion shaft may protrude from the first gear of the pinion shaft. A key or a key recess may be formed in a rotational axial direction of the pinion shaft on an outer circumferential surface of the rotation shaft of the pinion shaft. A key recess where the key of the pinion shaft is inserted or a key inserted to the key recess of the pinion shaft may be formed in an inner circumferential surface of the first adjustment gear and the second adjustment gear.

The vehicle may further comprise a stopper coupled to the pinion shaft to prevent the second adjustment gear from being separated from the pinion shaft. An outer circumferential surface of the pinion shaft has an anti-escape recess to which at least a portion of the stopper is inserted.

The stopper coupled to the pinion shaft has an O-ring shape having an opening.

According to the present embodiments, as the pinion shaft has a first adjustment gear and a second adjustment gear that comes in tight contact while applying pressure to the output shaft gear, the clearance caused between the pinion shaft gear and the output shaft gear may be compensated.

Further, it is possible to prevent rattle noise by preventing backlash between the pinion shaft gear and the output shaft gear.

### BRIEF DESCRIPTION OF THE DRAWING

The above and other objects, features, and advantages of the disclosure will be more clearly understood from the following detailed description, taken in conjunction with the accompanying drawings, in which:

FIG. 1 is a view schematically illustrating a vehicle;

FIG. 2 is a view schematically illustrating a connecting structure of a steering actuator provided in an electric power assist steering device of a vehicle;

FIG. 3 is a view schematically illustrating a connecting structure of a steering actuator provided in a steer-by-wire steering device of a vehicle;

FIG. 4 is a perspective view illustrating a vehicle steering actuator according to an embodiment;

FIG. 5 is a view illustrating an internal configuration of the vehicle steering actuator of FIG. 4;

FIG. 6 is a side view illustrating the pinion shaft of FIG. 5;

FIG. 7 is an exploded perspective view illustrating the pinion shaft of FIG. 6;

FIG. 8 is a view illustrating a state in which a first gear and a second gear are linearly moved by an elastic member; and

FIG. 9 is a view schematically illustrating a connecting structure of a steering actuator provided in a rack-pinion steering device of a vehicle.

### DETAILED DESCRIPTION

In the following description of examples or embodiments of the disclosure, reference will be made to the accompanying drawings in which it is shown by way of illustration specific examples or embodiments that can be implemented, and in which the same reference numerals and signs can be used to designate the same or like components even when they are shown in different accompanying drawings from one another. Further, in the following description of examples or embodiments of the disclosure, detailed descriptions of well-known functions and components incorporated herein will be omitted when it is determined that the description may make the subject matter in some embodiments of the disclosure rather unclear. The terms such as “including”, “having”, “containing”, “constituting” “make up of”, and “formed of” used herein are generally intended to allow other components to be added unless the terms are used with the term “only”. As used herein, singular forms are intended to include plural forms unless the context clearly indicates otherwise.

Terms, such as “first”, “second”, “A”, “B”, “(A)”, or “(B)” may be used herein to describe elements of the disclosure. Each of these terms is not used to define essence, order, sequence, or number of elements etc., but is used merely to distinguish the corresponding element from other elements.

When it is mentioned that a first element “is connected or coupled to”, “contacts or overlaps” etc. a second element, it should be interpreted that, not only can the first element “be directly connected or coupled to” or “directly contact or overlap” the second element, but a third element can also be “interposed” between the first and second elements, or the first and second elements can “be connected or coupled to”, “contact or overlap”, etc. each other via a fourth element. Here, the second element may be included in at least one of two or more elements that “are connected or coupled to”, “contact or overlap”, etc. each other.

When time relative terms, such as “after,” “subsequent to,” “next,” “before,” and the like, are used to describe processes or operations of elements or configurations, or flows or steps in operating, processing, manufacturing methods, these terms may be used to describe non-consecutive or non-sequential processes or operations unless the term “directly” or “immediately” is used together.

In addition, when any dimensions, relative sizes etc. are mentioned, it should be considered that numerical values for an elements or features, or corresponding information (e.g., level, range, etc.) include a tolerance or error range that may be caused by various factors (e.g., process factors, internal or external impact, noise, etc.) even when a relevant description is not specified. Further, the term “may” fully encompasses all the meanings of the term “can”.

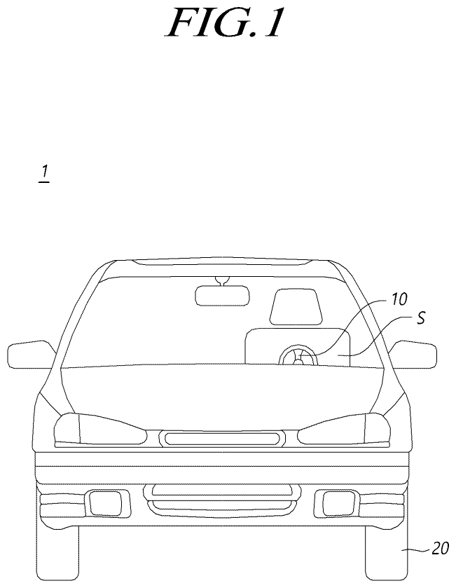

FIG. 1 is a view schematically illustrating a vehicle, and the vehicle 1 in the present embodiment is not limited to that illustrated, and may include all vehicles using internal combustion engines and electric batteries such as four-wheelers, three-wheelers, and two-wheelers.

The vehicle 1 of the present embodiment may include a steering angle setter 104 that sets a steering angle based on the driving path set by a driving path setter 102, and an electromotive steering device that assists manipulation force of the steering wheel 10 or perform steering based on the steering angle set by the steering angle setter 104.

In more detail, the driving path setter 102 may set a driving path considering the current location, destination, traffic situation, or the like, and may transfer the set driving path to the steering angle setter 104.

Further, the steering angle setter 104 may set the steering angle of the vehicle 1 based on the driving path set by the driving path setter, determine the steering angle suitable for the driving situation, and transfer it to the electronic control unit 400.

Further, the electronic control unit 400 may assist the manipulation force of the steering wheel 10 or enable steering according to the steering angle transferred from the steering angle setter 104.

In this case, the electromotive steering device may assist the driver's input or may completely autonomously control the vehicle 1.

The electromotive steering devices include electric power assist steering devices that assist the steering wheel's manipulation force using motors to provide convenience in driving manipulation, and steer-by-wire (SBW) steering devices that allow the vehicle to be steered using motors.

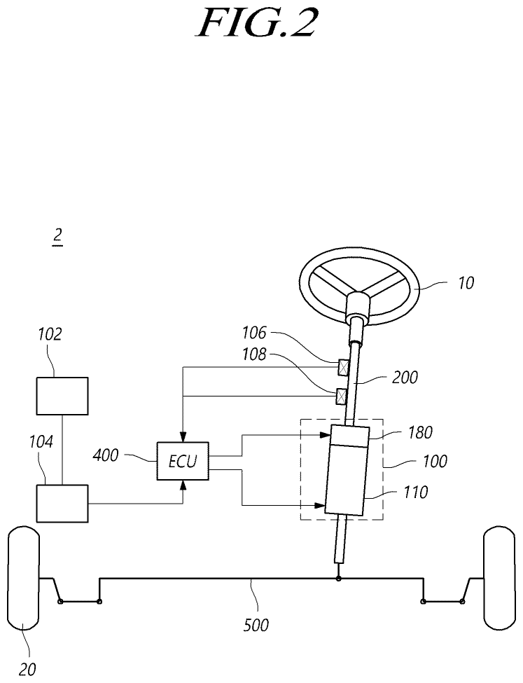

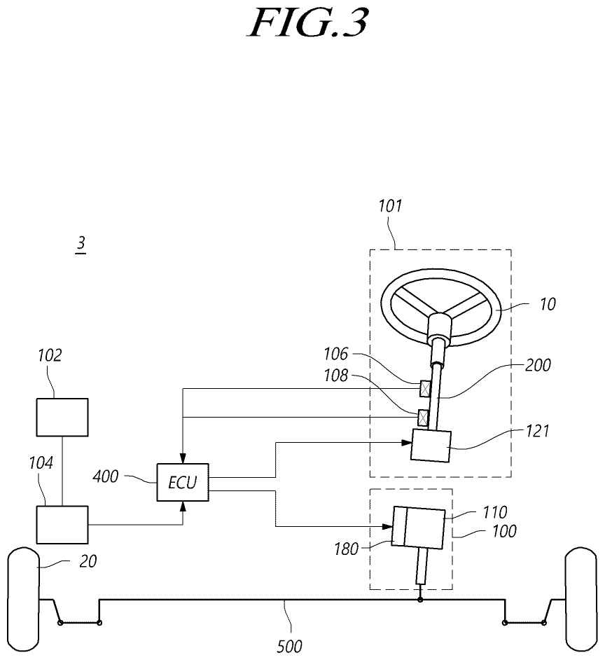

FIG. 2 is a view schematically illustrating a connecting structure of a steering actuator provided in an electric power assist steering system of a vehicle, and FIG. 3 is a view schematically illustrating a connecting structure of a steering actuator provided in a steering-by-wire steering system of a vehicle.

Hereinafter, various embodiments are described in detail with reference to the accompanying drawings.

Referring to FIG. 2, in an electric power assist steering device 2 according to the present embodiment, an angle sensor 106 and a torque sensor 108 may be coupled to one side of a steering shaft 200 connected with a steering wheel 10 and, when the driver manipulates the steering wheel 10, the angle sensor 106 and the torque sensor 108 which detect the manipulation transmit an electrical signal to the electronic control unit 400, and the electronic control unit 400 transmits an operation signal to the driving motor 180.

The electronic control unit 400 controls the driving motor 180 based on the electric signals transmitted from the angle sensor 106 and the torque sensor 108 and the electric signals transmitted from various sensors mounted on the vehicle.

Referring to FIG. 3, the steer-by-wire steering device 3 according to the present embodiments has a steerer 101 disposed close to the driver and a steering actuator 100 disposed close to the wheel 20. An angle sensor 106 and a torque sensor 108 are coupled to one side of the steering shaft 200 connected to the steering wheel 10 and, when the driver manipulates the steering wheel 10, the angle sensor 106 and the torque sensor 108 detecting the manipulation send an electrical signal to the electronic control unit 400 so that the reaction force motor 121 and the driving motor 180 are operated.

The electronic control unit 400 controls the reaction force motor 121 and the driving motor 180 based on the electric signals transmitted from the angle sensor 106 and the torque sensor 108 and the electric signals transmitted from various sensors mounted on the vehicle.

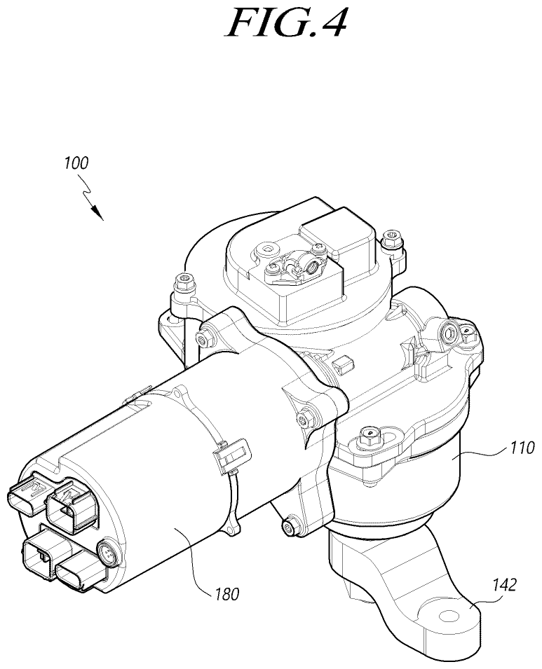

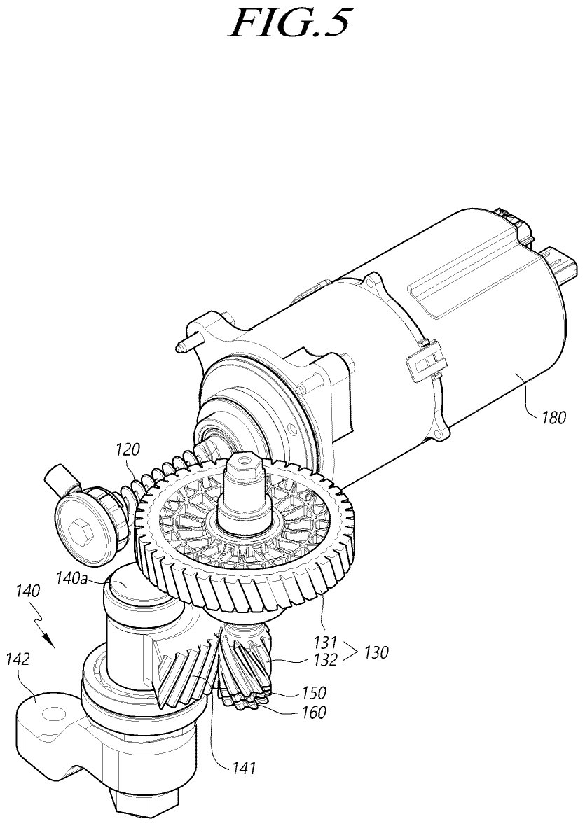

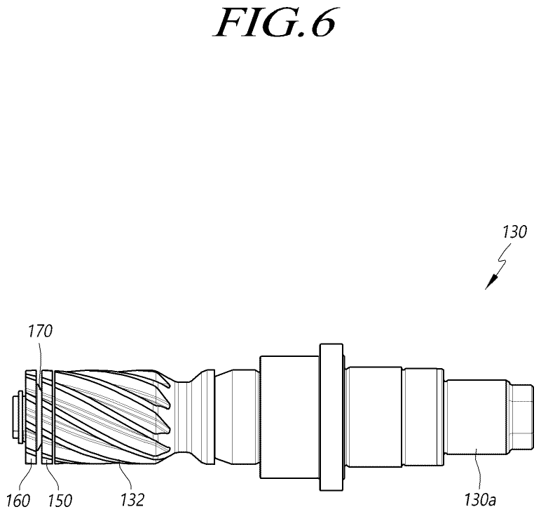

However, in the present embodiments, for convenience of description, the drawings illustrate the angle sensor 106 and the torque sensor 108 provided on the steering shaft 200 as steering sensors. However, a velocity sensor, a wheel steering angle sensor, a motor position sensor, various radars, lidars, or camera video sensors for transmitting steering information to the electronic control unit 400 may be provided, and a detailed description of the sensors is omitted. FIG. 4 is a perspective view illustrating a vehicle steering actuator according to an embodiment. FIG. 5 is a view illustrating an internal configuration of the vehicle steering actuator of FIG. 4. FIG. 6 is a side view illustrating the pinion shaft of FIG. 5.

Referring to FIGS. 4 to 6, the vehicle steering actuator 100 may include a housing 110, a worm 120 operably connected to a driving motor 180 to be rotatable by the driving motor 180, a pinion shaft 130, a worm wheel 131 provided on the pinion shaft 130 and rotatably engaged with the worm 120, an output shaft 140, a first adjustment gear 150, a second adjustment gear 160, and an elastic member 170. In the present embodiment, the vehicle steering actuator 100 may include a pinion shaft 130 connected to a steering shaft 200 and having a first gear 132, and an output shaft 140 having a second gear 141 rotatably engaged with the first gear 132 of the pinion shaft 130, and at least one first adjustment gear 150 provided on the pinion shaft 130 to be engaged with the second gear 141 of the output shaft 140 and configured to be linearly movable along a rotation shaft 130a of the pinion shaft 130, and at least one second adjustment gear 160 provided on the pinion shaft 130 to be engaged with the second gear 141 of the output shaft 140 and configured to be linearly movable along the rotation shaft 130a of the pinion shaft 130, wherein the first adjustment gear 150 is movably disposed between the first gear 132 and the second adjustment gear 160, and at least one elastic member 170 having an elastic material and disposed between the first adjustment gear 150 and the second adjustment gear 160.

The housing 110 may be provided on one side of the driving motor 180 to protect components positioned therein. For example, a plurality of housings 110 may be provided to cover each of the pinion shaft 130 and the output shaft 140 described below. Accordingly, it is possible to prevent foreign substances from penetrating into the pinion shaft 130 and the output shaft 140, and shield noise generated from the pinion shaft 130 and the output shaft 140.

The worm 120 may be rotated by receiving power from the driving motor 180. For example, the worm 120 may be connected to the rotation shaft of the driving motor 180, and may be rotatably supported in the housing 110 through a bearing.

The pinion shaft 130 may be connected to the steering shaft and may include a worm wheel 131 and a first gear 132 spaced apart from the worm wheel 131. For example, on the drawing, the worm wheel 131 may be provided above the pinion shaft 130 and the first gear 132 may be provided below the pinion shaft 130.

The worm wheel 131 may be disposed on a side portion of the worm 120 to be engaged with the worm 120. For example, the worm wheel 131 is installed on the outer circumferential surface of the pinion shaft 130 connected to the steering shaft to transfer the rotational force of the worm 120 by driving the driving motor 180 to the steering shaft.

The first gear 132 may be formed on the outer circumferential surface of the pinion shaft 130. Although the first gear 132 is illustrated as integrally formed with the pinion shaft 130, the pinion shaft 130 and the first gear 132 may be separately provided, and then, the first gear 132 may be coupled to one side of the pinion shaft 130.

The output shaft 140 may have a second gear 141 formed on one side thereof to be engaged with the first gear 132. Accordingly, the second gear 141 may be rotated by receiving a rotational force from the first gear 132.

The pinion shaft 130 and the output shaft 140 may be disposed in the same direction and may be disposed adjacent to each other. Further, the first gear 132 and the second gear 141 provided on the pinion shaft 130 and the output shaft 140, respectively, may be provided as helical gears with oblique teeth. Accordingly, the rotation shaft 130a of the pinion shaft 130 and the rotation shaft 140a of the output shaft 140 may have axes parallel to each other and may receive power.

A pitman arm 142 may be coupled to the rotation shaft 140a of the output shaft 140. For example, one end of the pitman arm 142 is connected to the lower end of the output shaft 140 and the other end is connected to the tie rod or knuckle arm, so that the wheel of the vehicle may be steered by the rotation of the pitman arm 142.

The first adjustment gear 150 may be disposed on one side of the first gear 132 to be engaged with the second gear 141, and may be formed to be linearly movable along the rotation shaft 130a of the pinion shaft 130. For example, the first adjustment gear 150 may be disposed below the first gear 132 and may be formed to have the same tooth shape as the first gear 132. In other words, when the first gear 132 is formed of a helical gear, the first adjustment gear 150 may also be formed of a helical gear.

The second adjustment gear 160 may be disposed to face the first adjustment gear 150 to be engaged with the second gear 141, and may be formed to be linearly movable along the rotation shaft 130a of the pinion shaft 130. Like the first adjustment gear 150, the second adjustment gear 160 may be formed to have the same tooth shape as the first gear 132. As the first adjustment gear 150 and the second adjustment gear 160 are formed to have the same tooth shape as the first gear 132, the second gear 141 may be engaged with all of the first gear 132, the first adjustment gear 150, and the second adjustment gear 160. Therefore, when the second gear 141 rotates, the first gear 132, the first adjustment gear 150, and the second adjustment gear 160 may rotate simultaneously.

The elastic member 170 may be disposed between the first adjustment gear 150 and the second adjustment gear 160. For example, the elastic member 170 may be provided as a circular disc spring. The elastic member 170 is provided as a disc spring having a through hole through which the rotation shaft of the pinion shaft 130 passes in a center thereof. In the present embodiment, the elastic member 170 is illustrated as formed of a disc spring, but may be implemented in various ways as long as it may be compressed and restored, such as a coil spring or a leaf spring.

A through hole 171 through which the rotary shaft 130a of the pinion shaft 130 passes may be formed in the center of the elastic member 170. In this case, the width of the elastic member 170 may be smaller than the width of the first gear 132 of the pinion shaft 130 to prevent the elastic member 170 from interfering with the external case. As the elastic member 170 is provided between the first adjustment gear 150 and the second adjustment gear 160, the first adjustment gear 150 and the second adjustment gear 160 are movable in opposite directions along the rotation shaft 130a of the pinion shaft 130.

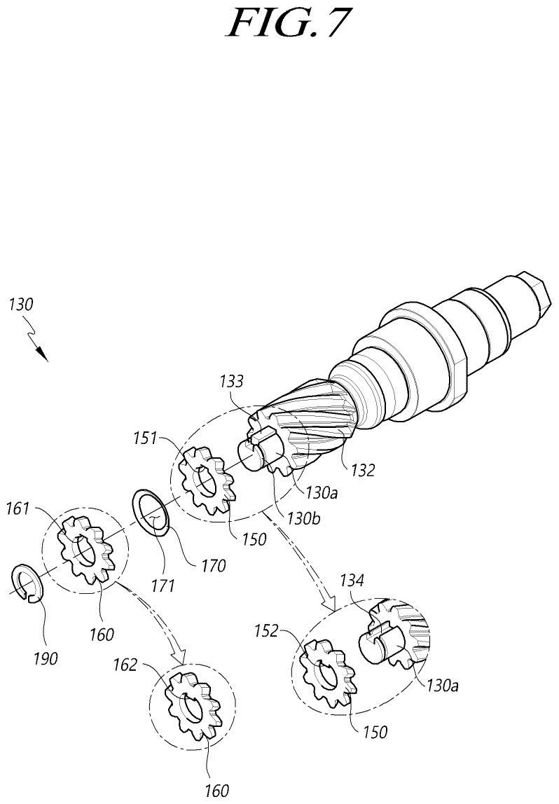

FIG. 7 is an exploded perspective view illustrating the pinion shaft of FIG. 6.

Referring to FIG. 7, the rotation shaft 130a of the pinion shaft 130 may protrude from the first gear 132 of the pinion shaft, and a key 133 or a key recess (134) may be formed in a rotational axial direction of the pinion shaft 130 on an outer circumferential surface of the rotation shaft 130a of the pinion shaft 130. The first adjustment gear 150 and/or the second adjustment gear 160 may have a key recess 151 and 161 where the key 133 of the pinion shaft 130 is inserted or a key (152, 162) inserted into a key recess (134) of the pinion shaft 130.

For example, when the key recess (134) is formed in the rotation shaft 130a of the pinion shaft 130, a key (152, 162) inserted into the key recess (134) of the pinion shaft 130 may be formed in the inner circumferential surface of the first adjustment gear 150 and the second adjustment gear 160 and, when the key 133 is formed in the rotation shaft 130a of the pinion shaft 130, the key recess 151 and 161 where the key 133 of the pinion shaft 130 is inserted may be formed in the inner circumferential surface of the first adjustment gear 150 and the second adjustment gear 160. By the structure, the first adjustment gear 150 and the second adjustment gear 160 are linearly movable along the rotation shaft 130a of the pinion shaft 130.

According to the present embodiment, a stopper 190 is coupled to the pinion shaft 130 to prevent the second adjustment gear 160 from being separated from the pinion shaft. An outer circumferential surface of the pinion shaft 130 has an anti-escape recess 130b into which at least a portion of the stopper 190 is inserted.

In other words, a stopper 190 fixed to one side of the pinion shaft 130 to prevent the second adjustment gear 160 from escaping off may be further included. For example, an anti-escape recess 130b may be formed in the outer circumferential surface of the pinion shaft 130, and the stopper 190 may be fixed to the pinion shaft 130 in such a manner that a portion of the inside thereof is inserted into the anti-escape recess 130b.

The stopper 190, coupled to the pinion shaft, has an O-ring shape with an opening and may be formed of a metal or resin material capable of being deformed and restored. As described above, as the opening is formed in one side of the stopper 190, the stopper 190 may be opened or closed through the opening. Therefore, when the stopper 190 is seated in the anti-escape recess 130b through the opening, the stopper 190 may be stably fixed to the pinion shaft 130.

As the stopper 190 is fixed to the anti-escape recess, the first adjustment gear 150, the second adjustment gear 160, and the elastic member 170 inserted into the rotation shaft 130a of the pinion shaft 130 may be prevented from escaping off the pinion shaft 130.

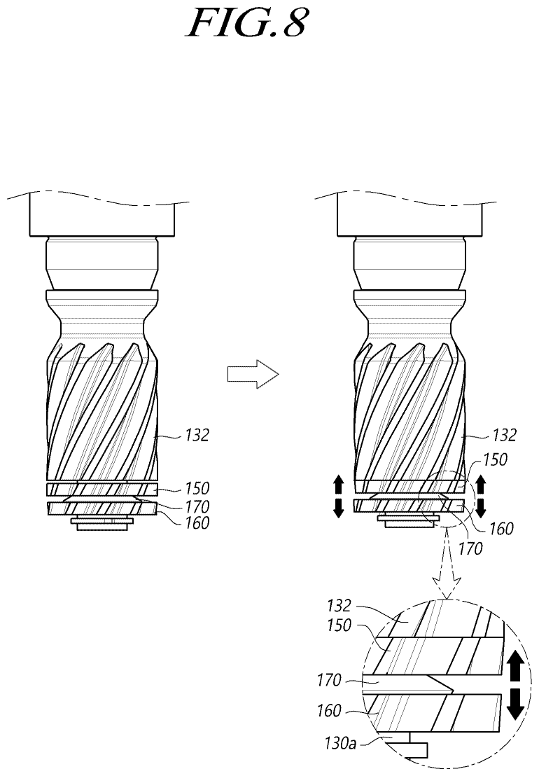

FIG. 8 is a view illustrating a state in which a first gear and a second gear are linearly moved by an elastic member.

Referring to FIG. 8, the first adjustment gear 150 and the second adjustment gear 160 may be linearly moved in opposite directions along the rotation shaft 130a of the pinion shaft 130 by the elastic member 170 disposed between the first adjustment gear 150 and the second adjustment gear 160. For example, the first adjustment gear 150 may move upward on the drawing along the rotation shaft 130a of the pinion shaft 130, and the second adjustment gear 160 may move downward on the drawing along the rotation shaft 130a of the pinion shaft 130.

In this case, since the teeth of the first adjustment gear 150 and the second adjustment gear 160 are obliquely inclined, when the first adjustment gear 150 moves upward, the teeth of the first adjustment gear 150 may be rotated in the left direction on the drawing. Conversely, when the second adjustment gear 160 moves downward, the teeth of the second adjustment gear 160 may be rotated in the right direction on the drawing. Therefore, when the first adjustment gear 150 and the second adjustment gear 160 are engaged with the second gear 141, the coupling force may be increased because the teeth of the first adjustment gear 150 and the second adjustment gear 160 press the teeth of the second gear 141 in opposite directions.

Further, even if a clearance occurs between the first gear 132 and the second gear 141 due to the wear of the first gear 132 and the second gear 141, the teeth of the first adjustment gear 150 and the second adjustment gear 160 may be brought in tight contact with the teeth of the second gear 141 by the elastic member 170, compensating for the clearance. Therefore, a backlash occurring between the first gear 132 of the pinion shaft 130 and the second gear 141 of the output shaft 140 may be prevented, and rattle noise caused by the backlash may be prevented.

In the present embodiment, one first adjustment gear 150, one second adjustment gear 160, and one elastic member 170 are provided on the rotation shaft 130a of the pinion shaft 130, but a plurality of first adjustment gears 150, a plurality of second adjustment gears 160, and a plurality of elastic members 170 may be provided. The at least one first adjustment gear 150 may comprise a plurality of first adjustment gears, the at least one second adjustment gear 160 may comprise a plurality of second adjustment gears, and the at least one elastic member 170 may comprise a plurality of elastic members. In this case, when a clearance occurs between the first gear 132 and the second gear 141, the area engaged with the second gear 141 increases, more effectively preventing rattle noise.

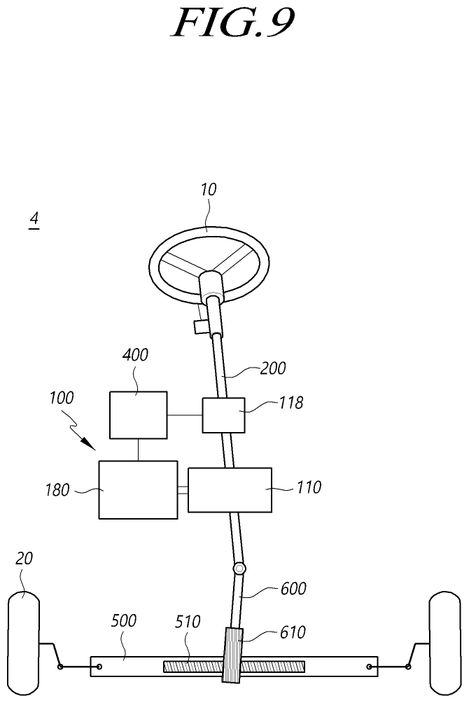

FIG. 9 is a view schematically illustrating a connecting structure of a steering actuator provided in a rack-pinion steering device of a vehicle.

Referring to FIG. 9, an example is described in which a steering actuator is applied to a structure in which a pinion gear engaged with a rack gear is formed on one side of a connecting shaft, and a steering shaft 200 is connected to the other side.

Referring to FIGS. 1 and 9, a vehicle 1 may include a steering shaft 200, a steering actuator 100, a torque sensor 118, a controller 400, a rack bar 500, and a connecting shaft 600.

The steering shaft 200 may be connected to the steering wheel 10 disposed in the driver seat S of the vehicle 1. For example, one side of the steering shaft 200 may be connected to the steering wheel 10 to rotate together with the steering wheel 10, and the other side may be connected to the connecting shaft 600 described below.

The steering actuator 100 is an auxiliary power device for relieving the driver's force, and may include a housing 110, a worm 120, a pinion shaft 130, an output shaft 140, a first adjustment gear 150, a second adjustment gear 160, an elastic member 170, a driving motor 180, and a stopper 190. Here, the steering actuator 100 has the same configuration as that described above, and thus, no detailed description thereof is given.

The torque sensor 118 may detect torque applied to the steering wheel 10 and output an electric signal proportional to the torque. For example, the torque sensor 118 may be installed on one side of the steering wheel 10 to detect the torsion of the steering wheel 10.

The controller 400 may generate a control signal based on the electric signal transferred from the torque sensor 118 and transfer the control signal to the driving motor 180. Accordingly, the driving motor 180 may generate power in response to the control signal transferred from the controller 400. Specifically, if the amount of torsion of the steering wheel 10 detected from the torque sensor 118 is transferred to the controller 400, the controller 400 may determine the current according to the amount of torsion of the steering wheel 10 for each vehicle speed according to a preset logic and output it to the driving motor 180. In other words, the rotation speed of the driving motor 180 may vary according to the vehicle speed and the amount of torsion of the steering wheel 10. Accordingly, the steering assistance force may be provided in a method of controlling the driving motor 180 according to the steering angle of the steering wheel 10.

The rack bar 500 may be connected to a wheel of the vehicle 1, and a rack gear 510 may be formed on one surface thereof. For example, the rack bar 500 may be formed in a cylindrical shape, and one side surface thereof may be processed to form the rack gear 510.

The connecting shaft 600 may have a pinion gear 610 engaged with the rack gear 510 formed on one side thereof, and the other side thereof may be connected to the steering shaft 200. As the pinion gear 610 of the connecting shaft 600 and the rack gear 510 of the rack bar 500 are engaged, the rotational motion transferred from the steering shaft 200 is converted into linear motion, controlling the angle of the wheel 20.

The above description has been presented to enable any person skilled in the art to make and use the technical idea of the disclosure, and has been provided in the context of a particular application and its requirements. Various modifications, additions and substitutions to the described embodiments will be readily apparent to those skilled in the art, and the general principles defined herein may be applied to other embodiments and applications without departing from the spirit and scope of the disclosure. The above description and the accompanying drawings provide an example of the technical idea of the disclosure for illustrative purposes only. That is, the disclosed embodiments are intended to illustrate the scope of the technical idea of the disclosure. Thus, the scope of the disclosure is not limited to the embodiments shown, but is to be accorded the widest scope consistent with the claims.

What is claimed:

1. A vehicle steering actuator, comprising:
a pinion shaft connected to a steering shaft and having a first gear;
an output shaft having a second gear rotatably engaged with the first gear of the pinion shaft;
at least one first adjustment gear provided on the pinion shaft to be engaged with the second gear of the output shaft and configured to be linearly movable along a rotation shaft of the pinion shaft;
at least one second adjustment gear provided on the pinion shaft to be engaged with the second gear of the output shaft and configured to be linearly movable along the rotation shaft of the pinion shaft, wherein the first adjustment gear is movably disposed between the first gear and the second adjustment gear; and
at least one elastic member having an elastic material and disposed between the first adjustment gear and the second adjustment gear.

2. The vehicle steering actuator of claim 1, further comprising:
a worm operably connected to a driving motor to be rotatable by the driving motor; and
a worm wheel provided on the pinion shaft and rotatably engaged with the worm.

3. The vehicle steering actuator of claim 1, wherein:
the rotation shaft of the pinion shaft protrudes from the first gear of the pinion shaft, wherein a key or a key recess is formed in a rotational axial direction of the pinion shaft on an outer circumferential surface of the rotation shaft of the pinion shaft, and
the first adjustment gear and/or the second adjustment gear has a key recess where the key of the pinion shaft is inserted or a key inserted to the key recess of the pinion shaft.

4. The vehicle steering actuator of claim 1, wherein the first gear and the second gear are helical gears.

5. The vehicle steering actuator of claim 1, wherein the first adjustment gear and the second adjustment gear have teeth having the same size as teeth of the first gear.

6. The vehicle steering actuator of claim 1, wherein the elastic member comprises a disc spring having a through hole through which the rotation shaft of the pinion shaft passes.

7. The vehicle steering actuator of claim 1, wherein a width of the elastic member is smaller than a width of the first gear of the pinion shaft.

8. The vehicle steering actuator of claim 1, further comprising a stopper coupled to the pinion shaft to prevent the second adjustment gear from being separated from the pinion shaft,
wherein an outer circumferential surface of the pinion shaft has an anti-escape recess to which at least a portion of the stopper is inserted.

9. The vehicle steering actuator of claim 8, wherein the stopper coupled to the pinion shaft has an O-ring shape having an opening.

10. The vehicle steering actuator of claim 1, wherein the first adjustment gear and the second adjustment gear are configured to be linearly movable in opposite directions to each other by the elastic member to compensate for a clearance between the first gear and the second gear.

11. The vehicle steering actuator of claim 1, wherein the at least one first adjustment gear comprises a plurality of first adjustment gears, the at least one second adjustment gear comprises a plurality of second adjustment gears, and the at least one elastic member comprises a plurality of elastic members.

12. An electromotive steering device, comprising:
a driving motor configured to generate power in response to a control signal received from a controller;
a pinion shaft connected to the driving motor and having a first gear;
an output shaft having a second gear rotatably engaged with the first gear of the pinion shaft;
a first adjustment gear provided on the pinion shaft to be engaged with the second gear of the output shaft and configured to be linearly movable along a rotation shaft of the pinion shaft;
a second adjustment gear provided on the pinion shaft to be engaged with the second gear of the output shaft and configured to be linearly movable along the rotation shaft of the pinion shaft, wherein the first adjustment gear is movably disposed between the first gear and the second adjustment gear; and
an elastic member having an elastic material and disposed between the first adjustment gear and the second adjustment gear.

13. The electromotive steering device of claim 12, further comprising:
a worm operably connected to the driving motor to be rotatable by the driving motor; and
a worm wheel provided on the pinion shaft and rotatably engaged with the worm.

14. The electromotive steering device of claim 12, wherein:
the rotation shaft of the pinion shaft protrudes from the first gear of the pinion shaft, wherein a key or a key recess is formed in a rotational axial direction of the pinion shaft on an outer circumferential surface of the rotation shaft of the pinion shaft, and
the first adjustment gear and/or the second adjustment gear has a key recess where the key of the pinion shaft is inserted or a key inserted to the key recess of the pinion shaft.

15. The electromotive steering device of claim 12, further comprising a stopper coupled to the pinion shaft to prevent the second adjustment gear from being separated from the pinion shaft,
wherein an outer circumferential surface of the pinion shaft has an anti-escape recess to which at least a portion of the stopper is inserted.

16. A vehicle, comprising:
a steering angle setter configured to set a steering angle of the vehicle based on a driving path set by a driving path setter; and
an electromotive steering device configured to assist a manipulation force of a steering wheel or perform steering based on the steering angle set by the steering angle setter,
wherein the electromotive steering device includes:
a driving motor configured to generate power based on a control signal received from a controller;
a pinion shaft connected to the driving motor and having a first gear;
an output shaft having a second gear rotatably engaged with the first gear of the pinion shaft;
a first adjustment gear provided on the pinion shaft to be engaged with the second gear of the output shaft and configured to be linearly movable along a rotation shaft of the pinion shaft;
a second adjustment gear provided on the pinion shaft to be engaged with the second gear of the output shaft and configured to be linearly movable along the rotation shaft of the pinion shaft, wherein the first adjustment gear is movably disposed between the first gear and the second adjustment gear; and
an elastic member having an elastic material and disposed between the first adjustment gear and the second adjustment gear.

17. The vehicle of claim 16, further comprising:
a worm operably connected to the driving motor to be rotatable by the driving motor; and
a worm wheel provided on the pinion shaft and rotatably engaged with the worm.

18. The vehicle of claim 16, wherein:
the rotation shaft of the pinion shaft protrudes from the first gear of the pinion shaft, wherein a key or a key recess is formed in a rotational axial direction of the pinion shaft on an outer circumferential surface of the rotation shaft of the pinion shaft, and
a key recess where the key of the pinion shaft is inserted or a key inserted to the key recess of the pinion shaft is formed in an inner circumferential surface of the first adjustment gear and the second adjustment gear.

19. The vehicle of claim 16, further comprising a stopper coupled to the pinion shaft to prevent the second adjustment gear from being separated from the pinion shaft,
Wherein an outer circumferential surface of the pinion shaft has an anti-escape recess to which at least a portion of the stopper is inserted.

20. The vehicle of claim 19, wherein the stopper coupled to the pinion shaft has an O-ring shape having an opening.
